(19) United States
(12) Patent Application Publication
(10) Pub. No.: US 2026/0039168 A1
(43) Pub. Date: Feb. 5, 2026

(54) VEHICLE BLOWER MOTOR

(71) Applicant: ILJIN GLOBAL HOLDINGS CO., LTD., Seoul (KR)

(72) Inventors: Woon Ju LEE, Seoul (KR); Jai Seong CHO, Seoul (KR); Ki Chang SHIM, Seoul (KR); Sung Dong CHANG, Seoul (KR); Young Jun HAHM, Seoul (KR)

(73) Assignee: ILJIN GLOBAL HOLDINGS CO., LTD., Seoul (KR)

(21) Appl. No.: 19/354,945

(22) Filed: Oct. 10, 2025

Related U.S. Application Data
(63) Continuation of application No. PCT/KR2024/004790, filed on Apr. 11, 2024.

(30) Foreign Application Priority Data
Apr. 12, 2023 (KR) 10-2023-0048447
Apr. 12, 2023 (KR) 10-2023-0048451
Apr. 12, 2023 (KR) 10-2023-0048452
Apr. 12, 2023 (KR) 10-2023-0048454
Aug. 18, 2023 (KR) 10-2023-0108503

(51) Int. Cl. H02K 5/22

(52) U.S. Cl. CPC H02K 5/22

(57) ABSTRACT

A blower motor for a vehicle includes: a rotor module and a stator module; a plate-shaped lower housing on which the rotor module and the stator module are mounted; an upper housing covering upper portions of the rotor module and the stator module; and a spacer that axially causes the lower housing and the upper housing to be spaced a predetermined distance apart.

### CROSS-REFERENCE TO RELATED APPLICATIONS

This application is a continuation of International Application No. PCT/KR2024/004790 filed on Apr. 11, 2024, which claims priority to Korean Patent Application No. 10-2023-0048447 filed on Apr. 12, 2023, Korean Patent Application No. 10-2023-0048451 filed on Apr. 12, 2023, Korean Patent Application No. 10-2023-0048452 filed on Apr. 12, 2023, Korean Patent Application No. 10-2023-0048454 filed on Apr. 12, 2023, and Korean Patent Application No. 10-2023-0108503 filed on Aug. 18, 2023, the entire contents of which are herein incorporated by reference.

### TECHNICAL FIELD

The present invention relates to a blower motor for a vehicle, and more particularly, to a blower motor for a vehicle that secures a sufficient amount of air flowing into the inside of the motor for cooling and heat radiation, and also improves an air flow rate.

### BACKGROUND ART

An air conditioning system of a vehicle may include a heater to warm the interior of the vehicle, an air conditioner to cool the interior air, or the like. When the air conditioner or the heater is in operation, the air conditioning system may operate by blowing cooled or heated air into the interior of the vehicle. This blowing may be accomplished through a blower motor.

Typically, a blower motor sucks in outside air and delivers the outside air to the interior of the vehicle, thereby creating ventilation. This intake of the outside air may be achieved by driving the blower motor to rotate a fan.

Some components of blower motors, particularly a stator and a PCB board, are electrical components that generate significant heat. Cooling and heat radiation are crucial for the normal operation and efficiency of blower motors.

However, conventional blower motors either lack adequate cooling and heat radiation, or their complex structures increase manufacturing costs.

### SUMMARY

### Technical Problem

The present invention is devised to solve the above-described problems of the related art, and an object of the present invention is to provide a blower motor for a vehicle that secures a sufficient amount of air flowing into the inside of the motor for cooling and heat radiation, and also improves an air flow rate.

### Technical Solution

A blower motor 1 for a vehicle according to one embodiment of the present invention includes: a rotor module 230 and a stator module 220; a plate-shaped lower housing 210 on which the rotor module 230 and the stator module 220 are mounted; an upper housing 240 covering upper portions of the rotor module 230 and the stator module 220; and a spacer that axially causes the lower housing 210 and the upper housing 240 to be spaced a predetermined distance apart.

The spacer may be at least one side wall 500 extending in an axial direction from an upper surface of the lower housing 210, and the side wall 500 may be formed integrally with the lower housing 210.

Also, a plurality of side walls 500 may be provided, and the plurality of side walls may be spaced apart from each other and arranged in a circumferential direction of a rotation axis of the blower motor 1 for a vehicle.

According to one embodiment of the present invention, the blower motor 1 for a vehicle may further include a stator module 220 disposed to surround the rotor module 230. An inner surface of the side wall is in contact with at least a portion of an outer circumferential surface of the stator module to fix the stator module in place in a horizontal direction.

The upper housing 240 may include a seating surface 243 for seating on an upper surface of the side wall. A fixing protrusion 540 may be formed on an inner surface of the above side wall 500 to prevent rotation of the stator module 220.

According to one embodiment of the present invention, at least one protrusion 510 may be formed on an upper surface of the side wall 500 for coupling to the upper housing 240. The upper housing 240 may be coupled to the side wall by heat fusion of the protrusion. The side walls may be configured to be open so that air flows between the side walls.

According to one embodiment of the present invention, the blower motor 1 for a vehicle may further include a flange 300 in which a through hole 310 is formed. The lower housing 210 may be disposed in the through hole 310, an air inlet may be formed on an inner circumferential surface of the flange 300 forming the through hole 310, and the air inlet may be formed on the circumferential inner surface of the flange 300 so that air flowing in through the air inlet flows into a gap between the lower housing 210 and the upper housing 240 that are spaced apart by the spacer.

### Advantageous Effects

According to one embodiment of the present invention, since a spacer opens a space between a lower housing and an upper housing, and most of the inside of a motor (particularly a stator module which generates a lot of heat due to a coil) is exposed, a sufficient amount of air can enter the inside of the motor. In addition, since air can directly enter the inside of the motor without any intermediate interference, an air flow rate can also be improved.

### DESCRIPTION OF DRAWINGS

FIG. 1 is a perspective view of a blower motor according to an embodiment of the present invention.

FIG. 2 is an exploded perspective view of the blower motor shown in FIG. 1.

FIG. 3 is an exploded perspective view of a motor module shown in FIG. 2.

FIG. 4 shows a lower housing in which a spacer according to one embodiment of the present invention is integrally formed.

FIG. 5 shows the motor module in which an upper housing is finally coupled to a lower housing according to one embodiment of the present invention.

FIG. 6 is a view showing an airflow in a blower motor for a vehicle according to one embodiment of the present invention.

### MODES OF THE INVENTION

The advantages and features of the present invention, and the methods for achieving them, will become clearer with reference to the embodiments described in detail below together with the accompanying drawings. However, the present invention is not limited to the embodiments disclosed below, but may be implemented in various different forms. The present embodiments are provided only to ensure that the disclosure of the present invention is complete and to fully inform those skilled in the art of the present invention of the scope of the invention, and the present invention is defined only by the scope of the claims. The same reference numerals refer to like elements throughout the specification.

When an element is referred to as being “above” or “on” another element, it includes not only being directly on the other element, but also having other elements intervening therewith. Conversely, when an element is referred to as being “directly on” or “just above,” it indicates that there are no intervening elements. “And/or” includes each and every combination of one or more of the mentioned items.

Spatially relative terms such as “below,” “beneath,” “lower,” “above,” and “upper” may be used to easily describe the relationship between one component and another, as shown in the drawings. Spatially relative terms should be understood to include different orientations of the element during use or operation in addition to the orientations shown in the drawings. The same reference numerals throughout the specification refer to the same components.

Although the terms first, second, and the like are used to describe various components and/or sections, these components and/or sections are not limited by these terms. These terms are merely used to distinguish one component or section from another. Accordingly, it should be understood that a first component or a first section referred to below may also be a second component or a second section within the technical concept of the present invention.

The embodiments described in the present specification will be described with reference to plan views and cross-sectional views, which are ideal schematic drawings of the present invention. Accordingly, the shapes of the illustrated drawings may be modified due to manufacturing techniques and/or tolerances. Accordingly, the embodiments of the present invention are not limited to the specific shapes illustrated, but also include changes in shapes resulting from the manufacturing process. Accordingly, the regions shown in the drawings have schematic properties, and the shapes of the regions shown in the drawings are intended to illustrate specific shapes of regions of the configuration, and are not intended to limit the scope of the invention.

Hereinafter, a preferred embodiment of the present invention will be described in more detail with reference to the attached drawings.

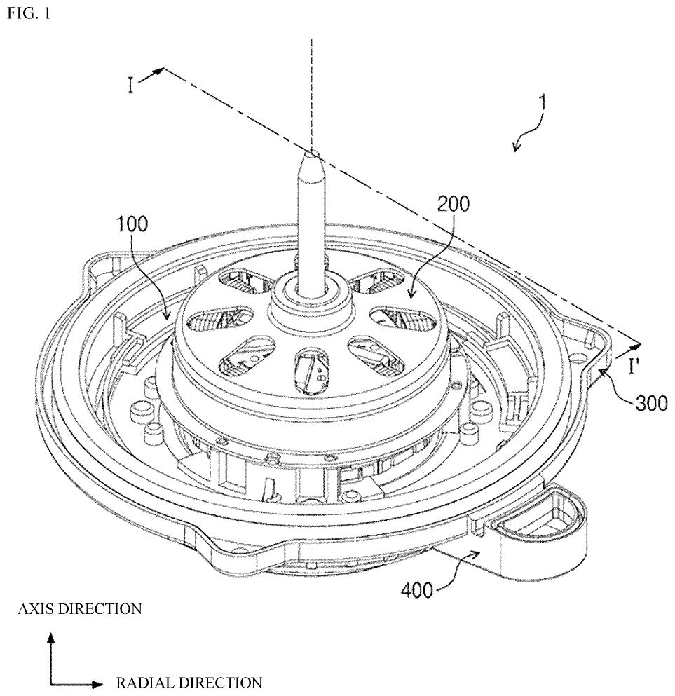

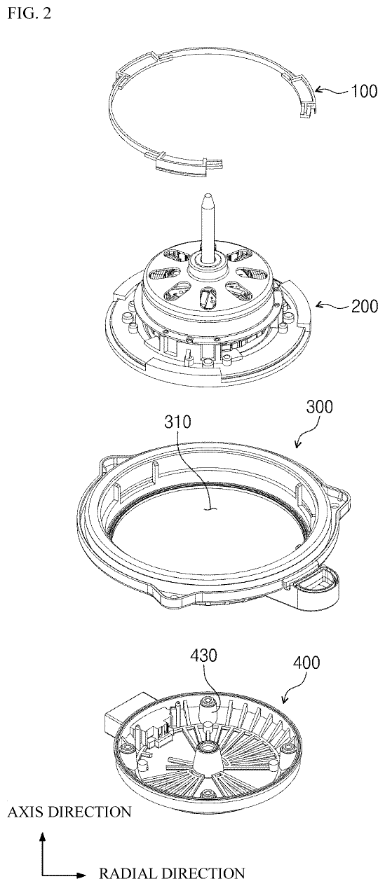

FIG. 1 is a perspective view of a blower motor according to an embodiment of the present invention. FIG. 2 is an exploded perspective view of the blower motor shown in FIG. 1.

Referring to FIGS. 1 and 2, a blower motor 1 may include a clamp 100, a motor module 200, a flange 300, and a cover 400. The clamp 100 is a component that fixes the motor module 200 to the flange 300 and may be, for example, in a ring shape with a portion omitted in a circumferential direction. First, the motor module 200 will be described as follows.

### 1. Motor Module

The motor module 200 is a module that receives electrical energy and drives a motor (more specifically, a rotor) to rotate a cooling wheel (not shown) to generate air flow.

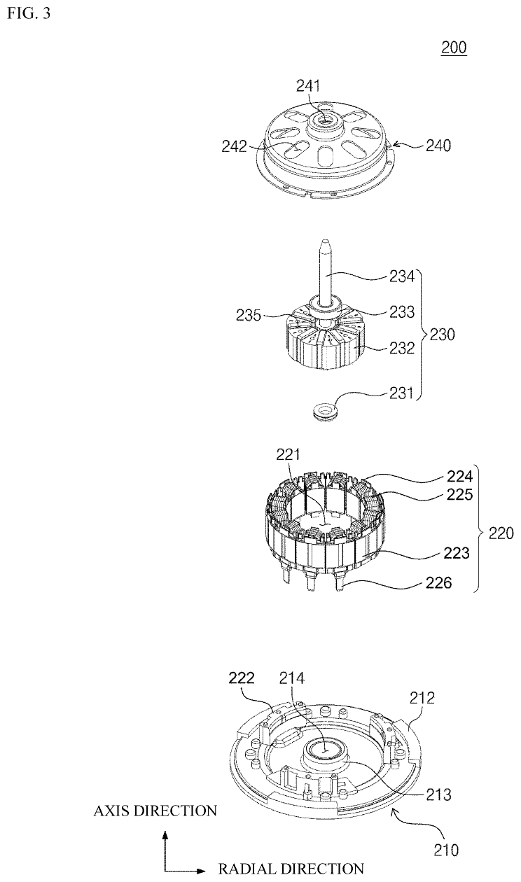

FIG. 3 is an exploded perspective view of the motor module shown in FIG. 2. Referring to FIG. 3, the motor module 200 according to one embodiment of the present invention may include a lower housing 210, a stator module 220, a rotor module 230, an upper housing 240, and a spacer.

First, the rotor module 230 includes a shaft 234, a rotor 232 that is press-fitted and fixed to the shaft 234, a first bearing 231 that is press-fitted and fixed to the shaft 234 to form an axis center and perform a function of reducing rotational resistance, and a second bearing 233.

The rotor 232 may be formed in a cylindrical shape and may be implemented with a structure in which a plurality of magnets are inserted therein. For example, each of the magnets may be a permanent magnet with a rectangular structure and has a function of generating magnetic flux.

Subsequently, the stator module 220, which is one of components of the motor module 200, is a module for electromagnetically rotating the rotor 232 and may include, for example, a stator core 223, an insulator 224, a coil 225, and a stator phase terminal 226.

The stator core 223 may be formed to have a hollow cylindrical shape so that the rotor 232 is disposed therein and may have a structure in which the coil 225 is wound. The insulator 224 is a structure for electrical insulation between the stator core 223 and the coil 225 and for connection between the stator core 223 and the stator phase terminal 226.

The coil 225 is electrically connected to the PCB board (not shown) through the stator phase terminal 226, through which electricity flows through the coil 225, and the coil 225 is wound around the stator core 223 to electromagnetically rotate the rotor 232.

Subsequently, the lower housing 210 is formed in a plate shape and is a component that covers lower portions of the rotor module 230 and the stator module 220, and the upper housing 240 is a component that covers upper portions of the rotor module 230 and the stator module 220.

Subsequently, the spacer is a component that causes the lower housing 210 and the upper housing to be spaced a predetermined distance apart from each other in an axial direction. Hereinafter, the spacer is described as being formed integrally with the lower housing 210, but it should be understood that this is not necessarily limited thereto. For example, the spacer may be formed integrally with the upper housing, or may be disposed between the lower housing and the upper housing as a separate member from the lower housing and the upper housing.

For example, when the spacer is formed integrally with the lower housing, the motor module 200 may be assembled by arranging the rotor module 230 and the stator module 220 on the lower housing 210 and finally connecting the upper housing 240 to the lower housing 210.

### 2. Spacer

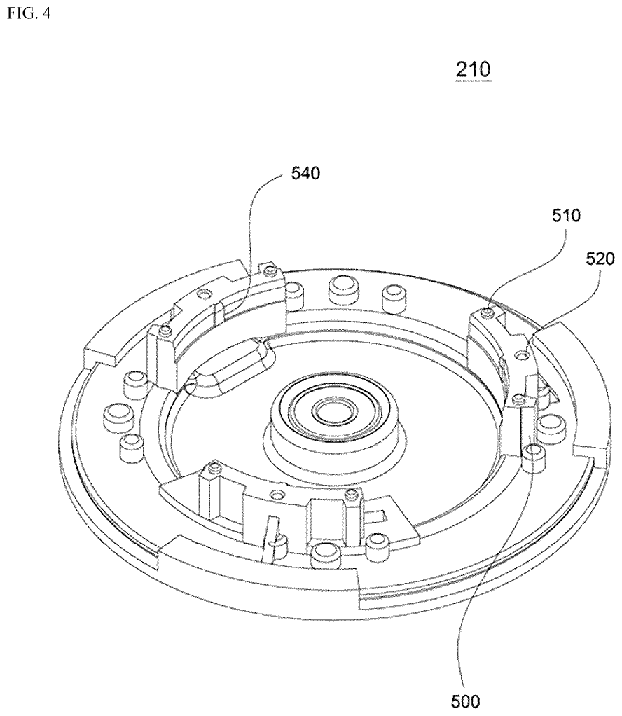

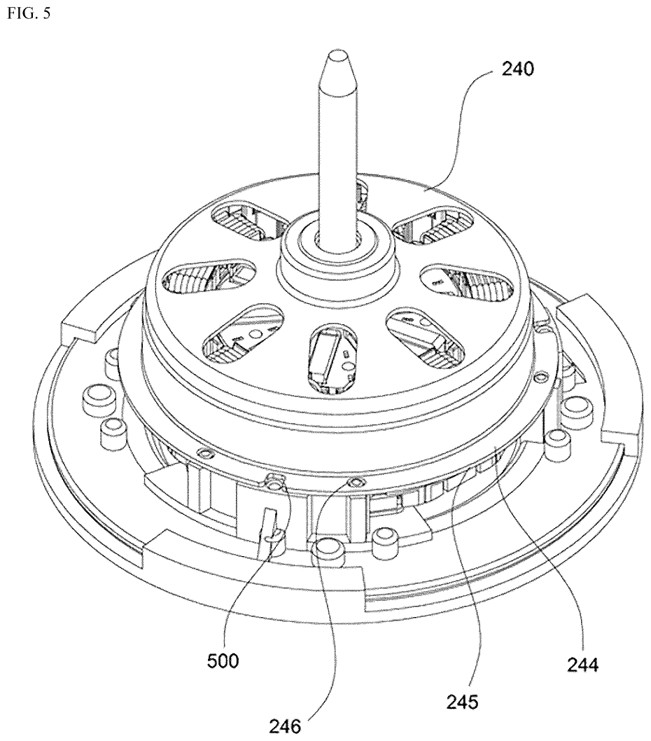

FIG. 4 shows the lower housing in which the spacer according to one embodiment of the present invention is integrally formed. FIG. 5 shows the motor module in which the upper housing is finally coupled to the lower housing according to one embodiment of the present invention. Hereinafter, the spacer, along with the lower housing, will be described in more detail.

According to one embodiment of the present invention, the lower housing 210 functions as a structure on which most components of the blower motor 1 are mounted. That is, as described above, the rotor module 230, the stator module 220, and the upper housing 240 are mounted on an upper surface of the lower housing 210, and the PCB board (not shown) and the cover 400 are mounted on a lower surface of the lower housing 210.

For example, the lower housing 210 may be a circular plate. First, with respect to the mounting of the rotor module 230, (as shown in FIG. 2) a central through hole 214 is formed at a center of the lower housing 210 and extends to pass through an upper surface to a lower surface thereof. A shaft 234 is inserted into the central through hole 214 and extends to pass therethrough. In addition, a ring-shaped central protruding portion 213 is formed in the lower housing 210 and protrudes upward while surrounding the central through hole 214. Accordingly, the first bearing 231 of the rotor module 230 is disposed in the central protruding portion 213 so that the rotor module 230 is mounted on the lower housing 210.

As described above, according to one embodiment of the present invention, the spacer is disposed between the upper housing 240 and the lower housing 210 so as to cause the lower housing 210 and the upper housing 240 to be spaced a predetermined distance apart from each other in the axial direction. For example, the spacer may be a side wall 500 formed integrally with the lower housing 210 and extending upward from the upper surface of the lower housing 210. Accordingly, as described above, the motor module 200 is assembled by arranging the rotor module 230 and the stator module 220 on the lower housing 210 and finally connecting the upper housing 240 to the lower housing 210, thereby simplifying the assembly of the motor module 200. A plurality of side walls 500 may be provided, and the plurality of side walls 500 may be arranged in the circumferential direction of the rotational axis while being spaced apart from each other.

In the present invention, a space between the plate-shaped lower housing 210 and the upper housing 240 is open by the spacer, and most of the inside of the motor (particularly the stator module which generates significant heat due to the coils) is exposed. This allows for a sufficient air flow rate (compared to conventional methods). Furthermore, since air flows directly into the motor without any intervening interference, the air flow rate may also be improved.

Furthermore, according to one embodiment of the present invention, the side wall 500 may be designed to function as a fixing structure for the stator module 220.

As shown in FIG. 4, the sidewall 500 may not be disposed at an edge of the upper surface of the lower housing 210, but may be disposed inward in a radial direction from the edge of the upper surface of the lower housing 210 to function as a fixing structure for the stator module 220. More preferably, the sidewall 500 may be disposed so that an inner surface of the sidewall 500 is in contact with an outer circumferential surface of the stator module 220 disposed on the lower housing 210, thereby fixing the stator module 220 in place in a horizontal direction. Accordingly, the upper housing 240 is finally coupled to an upper surface of the sidewall 500, which is integrally formed with the lower housing 210, in such a manner that the upper housing 240 presses the rotor module 230 and the stator module 220 from above, thereby finally fixing the stator module 220.

In addition, when the side wall 500 functions as a fixing structure of the stator module 220, a fixing protrusion 540 may be formed on an inner surface of the side wall to prevent the stator module 220 from unintentionally rotating in place. Since the stator module 220 has a groove formed on the outer circumferential surface of the stator module 220 due to its structure and function, preferably, the fixing protrusion 540 may be designed in a shape and size such that it is fitted into the groove on the outer surface of the stator module 220 to fix the stator module 220.

The upper housing 240 may include a seating surface 243 for seating on the upper surface of the side wall 500. For example, the upper housing 240 may have a fixed flange 244 extending outward in the radial direction along an end of a side surface of the upper housing 240 to face the upper surface of the side wall 500, and a lower surface of the fixed flange 244 functions as the seating surface 243.

For example, at least one fusion protrusion 510 for coupling to the upper housing 240 may be formed on the upper surface of the side wall 500. In this case, a through hole 246 may be formed at a corresponding position on an upper surface of the fixing flange 244 of the upper housing 240. For example, when the fixing flange 244 is seated on the side wall 500, the fusion protrusion 510 may extend to pass through the through hole 246, and the upper housing 240 may be finally coupled to the side wall 500 by heat-melting the fusion protrusion 510. For understanding, FIG. 5 shows a state in which the fusion protrusion 510 extends to pass through the through hole 246 before heat-melting. In addition, the upper housing 240 and the side wall 500 may be fastened and fixed through screw coupling. For example, as shown in FIG. 5, a screw hole 520 may be formed on the upper surface of the side wall 500 and a screw groove 247 may be formed at a corresponding position of the fixed flange 244 so that the side wall 500 is fastened and fixed by a screw (not shown). Heat fusion or screw bonding may be selected differently depending on, for example, the material of the side wall 500. For example, when the side wall 500 is made of a plastic material, heat fusion may be applied, and when the side wall 500 is made of aluminum, screw bonding may be applied in consideration of strength.

### 3. Airflow According to Cooling and Heat Radiation Structure

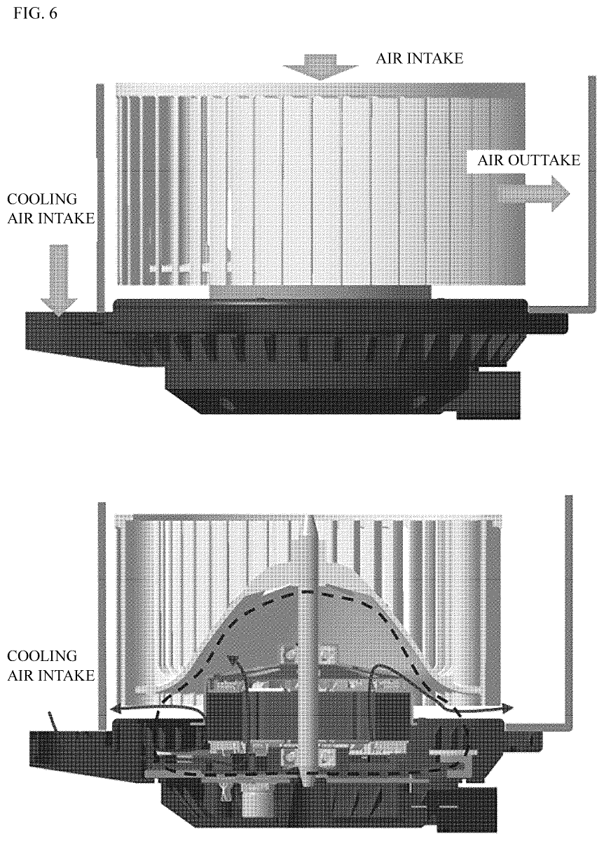

FIG. 6 is a view for describing the airflow of the blower motor for a vehicle according to one embodiment of the present invention.

As shown in FIG. 6, in the present invention, the rotor module 230 and the stator module 220 are mounted on the upper surface of the plate-shaped lower housing 210, and the lower housing 210 and the upper housing 240 are spaced apart by the spacer so that the space indicated by the blue dotted line is integrated into a single space. Accordingly, the cooling characteristics may be improved by internal air circulation as indicated in red below.

In addition, as an exemplary embodiment, the blower motor for a vehicle according to one embodiment of the present invention may further include the flange 300. The flange 300 is a component for accommodating the motor module 200 and connecting the motor module 200 to, for example, a duct of an air conditioning system. The flange 300 may be formed in a ring shape so that at least a portion of the motor module 200 is disposed inside the flange 300. For example, a through hole 310 may be formed at a center of the flange 300, the through hole 310 of the flange 300 may have a circular shape, and the motor module 200 may be disposed and fixed in the through hole 310 of the flange 300. An air inlet may be formed on an inner circumferential surface of the flange forming the through hole of the flange, and the air inlet may be formed on an inner circumferential surface of the flange 300 at a height corresponding to a gap between the lower housing 210 and the upper housing 240 that are spaced apart by the side wall so that air flowing in through the air inlet flows directly into the gap (as shown in FIG. 6).

Although the present invention has been described with reference to the above embodiments, it will be understood by those skilled in the art that various modifications and changes can be made to the present invention without departing from the spirit and scope of the present invention as set forth in the claims below. In addition, the embodiments disclosed in the present invention are not intended to limit the technical idea of the present invention, and all technical ideas within the scope of the following claims and equivalents thereof should be interpreted as being included within the scope of the rights of the present invention.

What is claimed is:

1. A blower motor (1) for a vehicle, comprising
a rotor module (230) and a stator module (220);
a plate-shaped lower housing (210) on which the rotor module (230) and the stator module (220) are mounted;
an upper housing (240) covering upper portions of the rotor module (230) and the stator module (220); and
a spacer that axially causes the lower housing (210) and the upper housing (240) to be spaced a predetermined distance apart.

2. The blower motor (1) for a vehicle of claim 1, wherein the spacer is at least one side wall (500) extending in an axial direction from an upper surface of the lower housing (210), and the side wall (500) is formed integrally with the lower housing (210).

3. The blower motor (1) for a vehicle of claim 2, wherein a plurality of side walls (500) are provided, and the plurality of side walls are spaced apart from each other and arranged in a circumferential direction of a rotation axis of the blower motor (1) for a vehicle.

4. The blower motor (1) for a vehicle of claim 3, further comprising a stator module (220) disposed to surround the rotor module (230),
wherein an inner surface of the side wall is in contact with at least a portion of an outer circumferential surface of the stator module to fix the stator module in place in a horizontal direction.

5. The blower motor (1) for a vehicle of claim 2, wherein the upper housing (240) includes a seating surface 243 for seating on an upper surface of the side wall.

6. The blower motor (1) for a vehicle of claim 3, wherein a fixing protrusion (540) is formed on an inner surface of the above side wall (500) to prevent rotation of the stator module (220).

7. The blower motor (1) for a vehicle of claim 2, wherein at least one protrusion (510) is formed on an upper surface of the side wall (500) for coupling to the upper housing (240).

8. The blower motor (1) for a vehicle of claim 7, wherein the upper housing (240) is coupled to the side wall by heat fusion of the protrusion.

9. The blower motor (1) for a vehicle of claim 3, wherein the side walls are configured to be open so that air flows between the side walls.

10. The blower motor (1) for a vehicle of claim 1, further comprising a flange (300) in which a through hole (310) is formed,
wherein the lower housing (210) is disposed in the through hole (310),
an air inlet is formed on an inner circumferential surface of the flange (300) forming the through hole (310), and
the air inlet is formed on the circumferential inner surface of the flange (300) so that air flowing in through the air inlet flows into a gap between the lower housing (210) and the upper housing (240) that are spaced apart by the spacer.
